(19) United States
(12) Patent Application Publication
(10) Pub. No.: US 2007/0265971 A1
(43) Pub. Date: Nov. 15, 2007

(54) Token based digital media distribution system

(76) Inventor: August R. Smalley, Austin, TX (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(21) Appl. No.: 11/801,464

(22) Filed: May 9, 2007

Related U.S. Application Data
(60) Provisional application No. 60/799,451, filed on May 10, 2006.

(51) Int. Cl. H04L 9/00

(52) U.S. Cl. 705/52

(57) ABSTRACT

A method for distributing digital media is provided herein. In accordance with the method, a web site (101) is provided from which a plurality of digital media files (209₁₁ to 209ₖₙ) are accessible, wherein each digital media file contains digital media associated with a particular artist (105ₗ to 105ₖ). A plurality of tokens (107₁₁ to 107ₖⱼ) are also provided, wherein each token has a unique identification code which can be utilized to gain access, via the website, to digital media files which are associated with the identification code. The identification codes of said plurality of tokens are associated with at least one digital media file which is accessible from the web site and which is associated with a particular artist, thereby creating a plurality of associated tokens.

### REFERENCE TO RELATED APPLICATIONS

The present application claims the priority benefit of U.S. Provisional Patent Application Ser. No. 60/799,451, entitled “TOKEN BASED DIGITAL MEDIA DISTRIBUTION SYSTEM”, which was filed on May 10, 2006, and which is incorporated herein by reference in its entirety.

### FIELD OF THE DISCLOSURE

The present disclosure relates generally to systems and methods for distributing digital media, and more particularly to token-based systems and methods for distributing digital media.

### BACKGROUND OF THE DISCLOSURE

According to the International Federation of the Phonographic Industry (IFPI), music companies made $1.1 billion from the legal downloading of music in 2005. These revenues, which are triple the amount reported in 2004, account for 6 percent of the global record industry. The IFPI expects this method of purchasing music to account for 25 percent of the global music industry by 2010.

Several businesses have sought to capitalize on this emerging market. For example, various merchants, such as book store giant Barnes & Noble, have web sites which allow consumers to browse product offerings, listen to portions of selected songs on recorded albums, and place an order online. Barnes & Noble also offers gift cards, similar in appearance to a credit card, which may be used to purchase any goods offered by the store, including the products offered for sale on their web site.

The Wal-Mart Corporation maintains a website that allows users to download selected songs for a fixed fee per song. The downloaded songs come with a license that allows them to be burned to a CD up to 10 times, or transferred an unlimited number of times to a portable device, such as an iPOD® portable digital audio player. Wal-Mart also offers music download electronic gift cards. These gift cards can currently be purchased with values of $10-$200, and are emailed to a designated recipient along with a PIN number. The PIN number may then be used by the recipient to download a like value of music that the user selects from the Wal-Mart website.

The second incarnation of Napster allows users, in exchange for a monthly fee, to download music and listen to it offline, or to purchase music selected by the user. The purchased music can then be downloaded and burned to a CD. The iTunes® music store run by Apple Computer Corporation offers a somewhat similar product.

The interest in downloadable music and other forms of digital media, and in online purchasing in general, is also reflected in the patent literature. Thus, U.S. Pat. No. 6,233,682 (Fritsch) describes a system to permit the purchase of audio music files over the Internet. In the system described therein, a PC user logs onto a vendor's web site and browses the songs available for purchase. The songs can be arranged by artist, music style, etc. Further, the vendor can provide suggestions on the web site, directing the PC user to songs that might be desirable, based on that PC user's previous purchases, his indicated preferences, popularity of the songs, paid advertising and the like. If the PC user is interested in a song, he has the option of clicking on a song to “pre-listen” to it, which may involve listening to a 20-second clip. If the PC user then wishes to purchase the song, he can submit his order by clicking on the icons located next to each song/album. The order will be reflected in the shopping basket, which is always visible on the screen. As the PC user selects more items, each and every item is displayed in the shopping basket. At any point in time, the PC user can review his selections and delete any items he no longer desires.

U.S. Pat. No. 6,868,394 (Mele) describes a system for simplified artist-buyer transactions. In accordance with the system described therein, a website is provided on a computer server system that contains (for browser access) a database of client recording artists, to each of whom is assigned an individual Web page exhibiting musical works for sale. A shopper browsing the website may evaluate and initiate purchase of one or more recordings directly with the website. The website charges each client artist a portion of the price of each purchase made by a shopper. The website and its owners take payment, obtain shipping data from the buyer, deduct a website usage fee from the purchase price, and send the purchase order and the client artist's payment to the client artist or client artist's representative.

U.S. Pat. No. 6,370,514 (Messner) describes a method for marketing and redeeming vouchers (meaning gift certificates or coupons) for use in online purchases. The method includes the use of a centralized voucher server for processing transactions. A purchaser may buy a gift certificate through a number of routes, such as through a brick and mortar store, over the telephone, or online. The gift certificate can be delivered to a recipient by regular mail, email, telephone or the like. The purchaser can select one or more merchants by type or category of goods sold at which the gift certificate will apply. Merchants may offer coupons through a number of venues for redemption via the voucher server.

Despite the clear and growing interest in downloadable music, most of the systems and methods currently available or described in the literature, including many of those described above, assume a traditional music distribution paradigm which has merely been modified to add an on-line component. In such traditional distribution systems, a substantial amount of the revenue generated from music sales goes to various middlemen such as the promoters, the record label, and retail establishments. Frequently, only a small percentage of these revenues are captured by the artist. Indeed, in many cases, an artist who utilizes such traditional music distribution systems ends up indebted to one or more of the middleman entities, and consequently sees little, if any, of the revenues generated by sales of the music he created.

Moreover, the traditional music distribution system is typically unavailable to (or ineffective for) new or unknown artists who have not yet established a sufficient reputation to generate commercial interest in their product. This places such artists in somewhat of a catch-22, since it denies them the very types of promotional services that might create interest in their product. At present, some record labels have attempted to address this problem by producing compilation CDs which they distribute to consumers for free, and which showcase the label's artists. However, compilation CDs are expensive to print and distribute, and are only available to artists associated with a record label. It is likely that a substantial number of these CDs are disposed of by the consumer without being listened to.

In light of the aforementioned problems, it will be appreciated that traditional music distribution systems represent an inefficient, expensive and, in many cases, an inaccessible pathway to the marketplace for many artists. The system of U.S. Pat. No. 6,370,514 (Mele) represents some improvement in this regard in that it provides a means by which a new or unestablished artist may offer his product for sale. However, this system does not provide a means by which the artist may actively create interest in his product, market that product himself, or sell that product for a price deemed mutually reasonable to the artist and the consumer.

There is thus a need in the art for a music distribution system that overcomes the aforementioned infirmities. In particular, there is a need in the art for a music distribution system that offers an artist a low cost means by which he may actively market his product. These and other needs are met by the systems and methodologies described herein.

### BRIEF DESCRIPTION OF THE DRAWINGS

FIG. 1 is an illustration of the token distribution scheme described herein;

FIG. 2 is an illustration of a file hierarchy useful in the systems and methodologies described herein;

FIG. 3 is an illustration of one possible means by which a purchaser of a token may remotely download digital media that the token is associated with; and

FIG. 4 is a flowchart depicting the steps in a particular, non-limiting embodiment of a transaction involving a token purchase and the subsequent download of digital media content associated with the token.

### SUMMARY OF THE DISCLOSURE

In one aspect, a method for distributing digital media is provided herein. In accordance with the method, a web site is provided from which a plurality of digital media files are accessible (these files may be provided for distribution by the artist, their label, any rights holders, representatives or agents of the artist, or other such entities), wherein each digital media file contains digital media associated with a particular artist. A plurality of tokens are also provided, wherein each token has a unique identification code which can be utilized to gain access, via the website, to digital media files which are associated with the identification code. The identification codes of the plurality of tokens are associated with at least one digital media file which is accessible from the web site and which is associated with a particular artist (and which may be further associated with particular digital content or a particular piece of digital media, such as a song or album), thereby creating a plurality of associated tokens, after which the plurality of associated tokens may be distributed to the artist.

In another aspect, a system for distributing digital media is disclosed herein. The system comprises (a) a web site from which a plurality of digital media files are accessible, wherein each digital media file contains digital media associated with a particular artist, and (b) a plurality of tokens, wherein each token has a unique identification code which can be utilized to gain access to (preferably specific) digital media files which are associated with the identification code, and wherein the identification codes of said plurality of tokens are associated with at least one digital media file which is accessible from the website and which is associated with a particular artist.

### DETAILED DESCRIPTION

As used herein, the term “artist” refers to both performing and non-performing artists and includes, without limitation, musicians, singers, writers, photographers, cinematographers, painters, sculptors, graphic designers, and craftsmen.

As used herein, the term “event” includes, without limitation, public or private events such as performances, concerts, exhibits, fairs, and trade shows which are attended by actual or potential consumers of an artist's product, whether or not those events are open to the public at large.

As used herein, the term “consumers” refers to actual or potential purchasers of an artist's product.

As used herein, the term “artist's product” refers to digital media associated with an artist.

As used herein, the term “digital media” refers to any artist work which is rendered in digital form, including audio recordings, digital images, video recordings, and audio-video recordings.

It has now been found that the aforementioned needs in the art may be met through the provision of a token-based digital media distribution system which may be used by artists to market their works directly to consumers. These tokens may be distributed, for example, at concerts or at other events attended by the artist, or may be distributed privately, with or without cost. The tokens allow the purchaser to download digital media content associated with the artist from a web site maintained by the token distributor or another entity.

In some embodiments, the user may be directed to a particular website based on the ID of the token. In some variations of such an embodiment, the target website may contain one or more modules parked on the website by the token distributor which enable consumers to download digital media content from that location. Such a module may run scripts the same as, or similar to, those run on a web site associated with the token distributor. Such a module may also have the same, or a similar, look and feel as the token distributor's website, may include some or all of the features of the token distributor's website, and may be supported by server capacity from the token distributor's website. Further, when the module is not being implemented for download services, the token distributor may use the module for advertising purposes, either to advertise for himself or for other entities. In some embodiments, the module may be adapted to use bandwidth either from the token distributor's website, or the website at which the module is parked.

The token-based digital media distribution system described herein does not require the middlemen common in traditional music distribution systems and does not require the artist to incur many of the other expenses of distributing music, such as the costs associated with burning CDs, printing jewel case covers, and the like. Hence, the cost to the artist of distributing the artist's music is significantly reduced, thereby providing the artist with a much lower barrier to market entry, reduced overhead, and larger profit margins. Consequently, the artist can offer his product at a low enough cost to attract impulse buyers. Impulse buying may be further facilitated by the size, shape, weight, prevalence and/or convenience of the token.

Moreover, the system and methodology described herein allows an artist to actively market his product at concerts, performances and other such events where interest in the artist is likely to be maximized. The tokens may be fabricated as small, lightweight articles, thus making them easier for a purchaser to carry on his person than traditional CDs, and are thus more attractive to a prospective purchaser at a concert or other point of sale where the purchaser is likely to have to carry his purchase for a significant amount of time. Furthermore, while a CD has predetermined content and is priced accordingly, the tokens utilized in the systems and methodologies described herein can be issued in any denomination, thus allowing the purchaser to invest in as little as a single song of his choosing from the artist's collection. The tokens may also be issued to the artist in sufficiently small denominations so as to prevent over-ordering of the tokens and dilution of the value of the artist's work, as many artists will liquidate excess inventory at very low prices. The tokens may also be associated with a particular song or album associated with the artist.

The systems and methodologies described herein are also more conducive to the way that music is being used today by an increasing number of consumers. In the past, consumers were accustomed to purchasing individual records or CDs, and to playing music directly from these media. However, with the evolution of sophisticated jukebox software that allows consumers to efficiently organize their music collections in a variety of ways and to easily apply a number of special effects, many consumers now prefer to play their music from PCs or from portable digital audio (or digital media) players such as those sold under the iPOD® brand.

To such consumers, the purchase of digital media on CDs, DVDs, HD-DVD, or other such media, or in BLU-RAY™ optical disk format or other such formats, is a cumbersome and undesirable way of acquiring music or other digital media files. Aside from the fact that the music may be arranged in such media differently than the consumer prefers and may contain items that do not interest the consumer, the purchase of music in such media requires the consumer to go through the time consuming process of loading the content onto a PC or a portable digital audio player prior to use. The time and expense inherent in this process may be avoided by various embodiments of the systems and methodologies described herein which allow the consumer to directly download music onto a PC or a portable digital audio player at the point of purchase. Once this is accomplished, the consumer can burn his own CDs, if desired, in which only the songs of interest to the consumer may be recorded in whatever sequence the consumer desires.

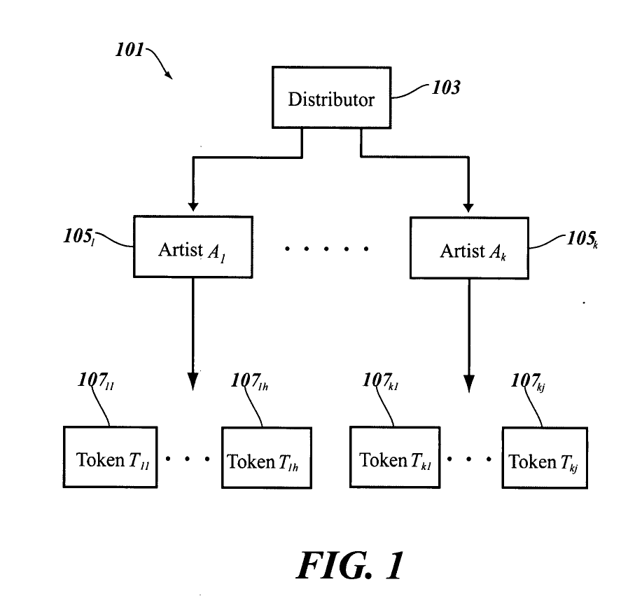

The foregoing aspects of the systems and methodologies described herein may be further appreciated with reference to the particular, non-limiting embodiment depicted in FIGS. 1-3 of a token-based digital media distribution system in accordance with the teachings herein. With reference to FIG. 1, the system 101 features a distributor 103 which is associated with a plurality of k artists 105₁ to 105ₖ denoted A₁, . . . , Aₖ. The distributor 103 distributes a plurality of tokens 107₁₁ to 107ₖⱼ denoted T₁₁, . . . , Tₖⱼ, among the artists. Thus, artist A₁ receives h tokens, and artist Aₖ receives j tokens, where 1≦h, j<p, and wherein p is some integer which represents the maximum number of tokens distributed by the distributor.

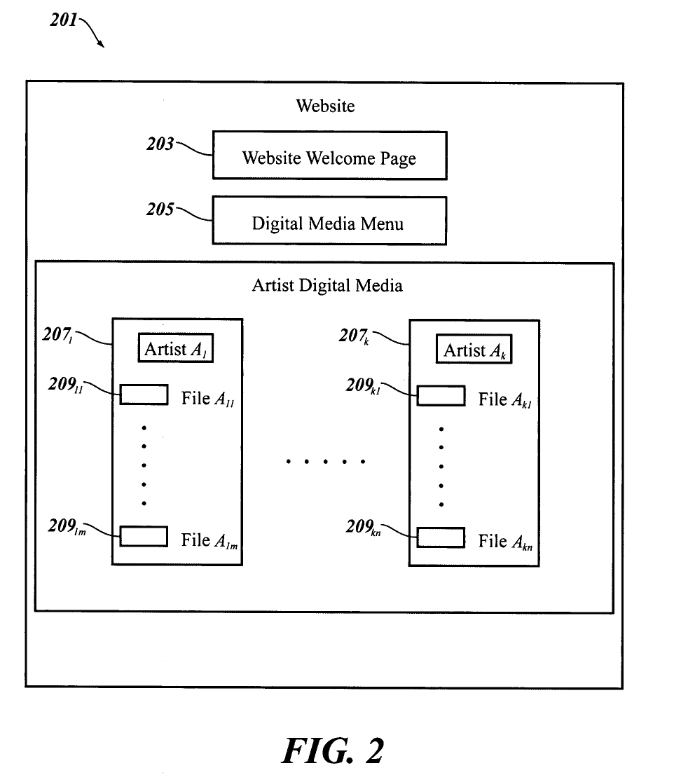

Referring now to FIG. 2, the distributor has a web site 201 associated with it. In the particular embodiment depicted, the website 201 has a welcome page 203, a digital media menu 205 and a plurality of artist subfolders 207₁, . . . , 207ₖ which are accessible from the digital media menu 205 and which are associated, respectively, with artists A₁, . . . , Aₖ. Each of the artist subfolders 207₁, . . . , 207ₖ contain the digital media files associated with a particular artist Aᵢ who has digital media files 207ᵢ₁, . . . 207ᵢⱼ accessible on the web site. The digital media files may open on the same or on a different web page or web site.

The web site 201 (and any web based content which is associated with it, linked to it, or accessible from it) may also include a variety of items in addition to downloadable files. These items may include, but are not limited to, promotional materials for the artist, banner advertisements, chat features, lyrics, photos, video clips, streaming audio, promotions, artist related merchandise, artist links (possibly including email addresses, phone numbers, postal addresses, or agent/label contact information), links to the distributor or to various third parties, blogs, comment sections, and links to other web pages. The web site 201 may also contain software which allows users to create playlists from purchased music, and/or to burn disks directly from the site.

One skilled in the art will appreciate that a wide number of variations are possible to the website of the type depicted in FIG. 2. For example, rather than having all of the downloadable content available from a single website, the website 201 may contain links to other websites that have some or all of a particular artist's product available for download. In one such embodiment, for example, each artist may be given his own website which is linked to the website 201. Each of the linked websites may contain a similar layout or navigational scheme, but may be customized with logos, color pallets, and other items unique to the artist. Thus, for example, in some embodiments, the distributor may provide a general artist template so that artists can access their own page and make changes in a manner similar to that provided by such sites as www.myspace.com and www.thefacebook.com. A particular, non-limiting embodiment of a website suitable for use in the practice of some embodiments of the systems and methodologies described herein may be found at http://www.cardtunes.net/, which is incorporated herein by reference in its entirety.

It will also be appreciated that the website 201 may actually be implemented as a group of websites. The websites within the group may have similar features and/or a similar look and feel, but may be split along certain lines (e.g., by genre). Preferably, upon entry of a PIN or ID at any website in the group, the user will be directed to the same website for the download of digital media content.

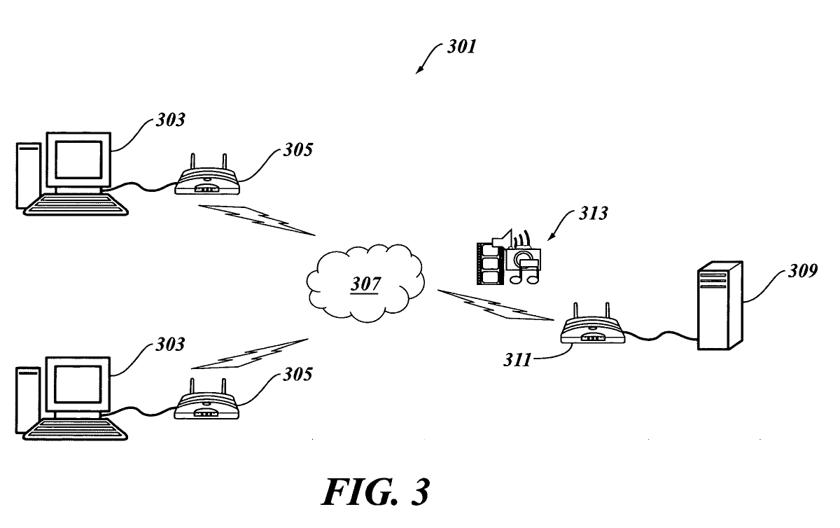

FIG. 3 depicts one particular, non-limiting embodiment of a means by which a consumer may download digital media content in accordance with the systems and methodologies disclosed herein. In the particular embodiment 301 depicted, a plurality of PCs 303 (which may be clients, servers, or database servers), each equipped with a modem 305 and associated with a particular consumer, may utilize the Internet 307 to access digital media content 313 stored on one or more servers 309 associated with the distributor. In this particular embodiment, the server 309 is also connected to the Internet 307 via a modem 311.

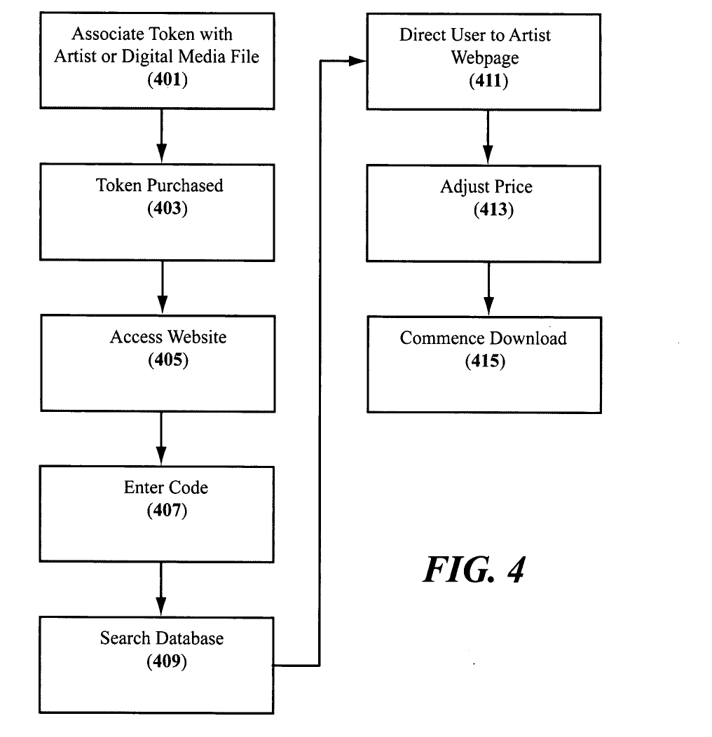

FIG. 4 illustrates a particular, non-limiting example of the use of a digital media distribution system in accordance with the teachings herein. As shown therein, a consumer purchases 403 a token at an event. Prior to or during the sales transaction, the token is associated 401 with a particular artist or other entity to which the token has been sold. The token may be further associated with one or more particular digital media files which are stored in a database, and which are associated with that artist or entity. Preferably, the digital media files are associated with a particular song, album, or compilation produced in whole or in part by the artist or entity.

Subsequently, the consumer visits 405 a website designated for redemption of the token, and thus arrives at the homepage of the website. There, the user enters a code 407 associated with the token into a dialog box provided for that purpose, it being understood that dialog boxes for this or other purposes may be provided at various places within the website. Upon entry of the code, a search engine associated with the website queries 409 the database for a match to the entered code. If a match is found, the user is redirected 411 to a web page associated with the artist or entity and which features the particular digital media file (or group of digital media files) which have been associated with the artist or entity, and/or which have been associated with the token. In some embodiments, this web page may contain thumbnails of other albums produced by the artist, which may be hot linked so that, while the user is downloading digital media content, he can browse (and possibly select for purchase) other content produced by the artist.

The code will be linked to a particular file or group of files contained in subfolders located beneath one or more parent folders displayed on the web page associated with the artist or entity, and which contain digital media content associated with that artist or entity. The nature of the subfolders is that they will always be linked to a parent folder associated with the artist or entity. Hence, the digital media file and the artist/entity form a parent/child relationship so that all codes associated with a particular digital media file (or files) from a particular artist will indicate both the particular “unlocked” digital media file and the parent file. Consequently, the search engine is able to use the code to direct a user to the proper artist/entity web page from which the appropriate digital media files purchased by the user (and associated with that artist/entity) may be downloaded.

When the user enters the code and is directed to the appropriate web page, one or both of the following two events may occur: (1) the price of the digital media file (or group of digital media files) corresponding to the token changes 413 from its current value to “$0.00”, or else there is some other suitable indication that the digital media files have been paid for; or (2) the download 415 of the digital media file (or group of digital media files) commences, a process which may involve suitable prompts to the user to approve the download and/or to provide suitable instructions concerning the download. These instructions may include directions as to the location to which the file is to be downloaded, or the type or format of the file to be downloaded. In some embodiments, the user may be given the option to preview digital media content before the download commences, and may be given the opportunity to substitute that digital media content with other digital media content produced by the artist.

In some of the foregoing embodiments, a token may be associated with a particular digital media file such that the purchaser of the token obtains the right to download that particular file. However, it will be appreciated that the token need not be associated with a particular digital media file indefinitely. For example, certain events may occur (such as the release of a new album) which make it desirable to change the digital media file (or files) which a token corresponds to. In such an event, the artist or entity that has originally purchased the tokens may contact the token distributor or another suitable party and request that the correspondence between one or more tokens and one or more digital media files be changed. In some embodiments, this correspondence may be changed directly by the artist or entity which has purchased the tokens as, for example, by logging onto a web site associated with the token distributor and completing an automated dialog, or speaking to a person at a help desk.

In other embodiments, the token distributor may provide the artist or entity that has originally purchased the tokens with label kits which indicate the association between the tokens and the digital media files, or which indicate that the original correspondence between the tokens and the digital media files has changed. These label kits may include a plurality of labels which may be attached to a surface of a token, and may be customized to the artist or entity. In the event of a change in the association between the tokens and the digital media files, the labels on the tokens may be simply replaced to indicate the new association. In some embodiments, the artist or entity may be required to bring the change to the attention of the token distributor as, for example, through a telephone help desk or a web interface.

In still other embodiments, the token distributor may distribute ID or PIN numbers rather than physical tokens. In such embodiments, the ID or PIN numbers may be associated with particular digital media files and/or artists or other entities as noted above. However, the artist or a third party (such as a token vendor) will assume responsibility for creating tokens associated with the ID or PIN numbers. For example, if the third party is a token vendor, that party may generate a set of tokens having the ID or PIN numbers generated by the distributor printed or inscribed thereon or, in the case that the token contains a magnetic strip or other memory media, recorded in that media.

This embodiment is desirable in that it allows the artist or entity to completely customize the tokens as they see fit, independently of the distributor, without compromising the distributor's ability to manage the file associations and electronic distribution of digital media content. For example, the artist or entity may choose unique embodiments of the tokens (e.g., as key chains or laser pointers) and may customize the tokens with color palettes, logos, emblems or designs associated with the artist or entity, all of which may occur independently of the party which distributes the IDs or PINs.

In variations of the foregoing embodiment, the distributor of the IDs or PINs may provide each artist or entity with a token package. This package may include software for customizing the tokens (which may contain a variety of token templates with editable fields and color schemes), and may also include token blanks. Such an approach is desirable in that, while it still permits customization by the artist or entity, this customization may be achieved at a lower cost than might be the case if the artist or entity had to work with a third party vendor to create a token design from scratch.

While the systems and methodologies have been primarily described and illustrated with respect to their use in distributing music to consumers, one skilled in the art will appreciate that these systems and methodologies may be utilized to distribute a variety of digital media content in a variety of industries and settings. For example, a painter or photographer may utilize this system to distribute digital copies or renditions of his artwork so that a visitor to his gallery can review his works from their PC, consider a purchase of an original work, save one or more images of the artist's work as a background or screensaver, or partake in other such activities.

The painter or photographer may also use this system to permit a consumer to download a digital copy of a painting or photograph, and/or a certificate or license authorizing the consumer to have the image printed or reproduced a predetermined (or, as the case may be, an unlimited) number of times. To this end, it is to be noted that services such as www.shutterfly.com currently exist which make this process possible. In some embodiments, the website from which the digital copy, certificate or license is obtained may also contain links to approved third parties which can provide such additional services as mounting, framing or matting, and which may be authorized to produce high quality renditions of the artwork based on the digital copy thereof or with proof of a certificate or license.

Similarly, a cinematographer (or agent thereto) may utilize the systems and methodologies described herein to distribute his works, or abbreviated clips or images thereof, to viewers at a preview, film festival, concert or showing. In such an application, the cinematographer's website or web pages may contain useful background information about a film, such as information concerning the actors and actresses in the film and other films produced by the cinematographer.

It will also be appreciated that, while the distribution of tokens at a performance or other such event is particularly advantageous in that it presents sales opportunities at a time when interest in the artist's product is likely to be maximized, the tokens may also be distributed in a variety of other ways. For example, the tokens may be detachably embedded in magazines or other printed media, may be distributed with cereal boxes or with other consumer products, may be mailed to consumers as part of a promotional campaign, or may be sold at stores or other retail establishments.

It will further be appreciated that the tokens may be utilized as a less expensive, more lightweight, and more convenient embodiment of the traditional “compilation CD”. As such, the tokens may be passed out at concerts or performances by a record label or other such entity, and may highlight particular tracks from various artists represented by the record label.

The tokens described herein have a number of advantages over gift cards which are currently available and which may be used for the on-line purchase of music. In particular, when a consumer purchases a gift card, the consumer is not purchasing any particular piece of music or digital media. Rather, the consumer in the gift card paradigm chooses from a selection of digital media available on a vendor website. That selection will typically contain content from many different artists or content creators/providers.

By contrast, in many of the embodiments of the systems and methodologies described herein, the purchaser of a token is purchasing particular digital media content (e.g., a particular song, album or digital media file) from a particular artist, group, or other digital media author/creator. Hence, the token-based media distribution systems described herein provide a means by which a consumer or fan may directly support an artist and/or a portion of that artist's music or digital media content. This approach is also advantageous to the artist, group or digital media author/creator because that party receives immediate payment for the sale of the token. By contrast, in a conventional digital media distribution system, such a party is usually forced to wait until a third party vendor receives payment for a sale of the party's digital media content, processes the payment, and then forwards the party's share of the payment to them. Moreover, in many embodiments of the systems and methodologies described herein, this party retains control over the price of the digital media content.

It will further be appreciated that the tokens utilized in the systems and methodologies described herein may take a number of forms. For example, the tokens may have the appearance of a credit card or gift card, and may have a magnetic stripe or other storage media thereon that allows information on the card, such as the credit available on the token or the artist whose digital media is associated with the token, can be viewed, accessed and/or modified. The tokens may also be implemented as smart cards, and may have various security features, such as tamper resistance and logos or holographs to verify authenticity. The tokens may also be implemented as fabs or keys which can be inserted into a drive or reader, and which may automatically launch a web browser and access the appropriate web pages to allow the user to download digital media content.

In a preferred embodiment, the tokens are in the form of a card having a PIN number thereon which may or may not be obscured by a scratchable material. After the token is purchased, the purchaser may remove the scratchable material to reveal the PIN number. This PIN number may then be entered online to retrieve digital media content. In some embodiments, other information may be required in addition to the PIN for security purposes. This information may include, but is not limited to, the color of the token, information about the place, date or time at which the token was issued, information about the artist to which the token corresponds, and other such information. In some embodiments, entry of a PIN may be followed by, or associated with, a user registration process. Such a registration process may require the user to provide personal information (e.g., an email address, home address or phone number, or identification), choose a password, or perform other such actions.

In some embodiments, virtual tokens may be used in place of, or in conjunction with, physical tokens. Such virtual tokens may take a variety of forms. For example, the virtual tokens may be executable files, programs, scripts, software modules, or keys. These tokens may be imparted to the purchaser or end user in a number of ways. For example, the virtual tokens may be distributed at an event where they may be, for example, downloaded onto a purchaser's MP3 player, personal digital assistant (PDA), handheld electronic device, cell phone, laptop, handheld computer, fab, credit card, smartcard, memory device, or other such device or article.

This approach has a number of potential benefits. For example, since the virtual tokens can be constructed as relatively small files, downloading of the virtual tokens may be extremely fast compared to the time required to download digital media files which may be associated with the tokens. Hence, acquiring a virtual token can require significantly less transaction time, which in turn can translate into shorter lines, a larger number of total transactions, and better conditions for impulse purchases.

Moreover, the tokens may be distributed wirelessly during an event as part of special effects or promotions. For example, during a portion of a concert, the tokens may be communicated wirelessly (using suitable wireless or RF signals) over the audience, where they can be received and recorded by an appropriate device or article belonging to or associated with an attendee. As a specific example, the tokens may be written to a medium embedded in, or disposed upon, a ticket stub, bracelet, or other such item associated with (and preferably distributed at) an event, and may provide access to special promotional offers, downloads, or digital media content. In some embodiments, this may occur during the event itself, with little or no action required on the part of the attendee.

In other embodiments, the ID or PIN number of a token purchased at a concert or other event may be read (as through wireless means, by an RF detector, or through other suitable means), registered or detected by one or more devices during the event. The ID or PIN number may then be used for various purposes such as, for example, the awarding of door prizes, the addition of the purchaser to an email list, or the assigning of website privileges to the token purchaser.

The virtual tokens may also be distributed in a separate medium that is capable of interfacing with various electronic devices. In some embodiments, the virtual token may be used by the purchaser to gain access to digital media using any of the methodologies described herein. In other embodiments, the digital media may be downloaded onto any of the aforementioned devices at the event, in which case the virtual tokens may be used by the purchaser for one or more additional functions.

For example, the purchaser may use the virtual token to obtain one or more back-up copies of the digital media in the event that the original download is lost or corrupted. Since the virtual token will typically take up a relatively small or negligible amount of memory, it may be utilized as part of an effective back-up strategy for a purchaser wishing to protect a collection of much larger digital media files. For example, in the event of the loss of digital media files due to theft, hard drive malfunction, natural disaster, or other such event, a purchaser may use the virtual tokens to replace lost files.

In some embodiments, the tokens may be utilized as a security feature to prevent unauthorized reproduction or use of the digital media files. For example, the tokens may be utilized as keys that permit digital media files to be accessed by a player or other software, and the software may be configured to verify the authenticity of the key prior to accessing the digital media files, either through a network connection or by other suitable means. If a purchaser reports the loss or theft of a token and/or any associated digital media files and provides appropriate identification, a new token may be issued and the previous token or key may be disabled, thereby preventing access to the files through the use of the previous token. In some embodiments, the purchaser may also be entitled to replace the lost or stolen files at no cost (or at a reduced cost) as by, for example, re-downloading the files from one or more authorized web sites.

The token may also permit the purchaser to obtain one or more copies of the digital media in one or more other file formats, or in one or more other media types, such as a physical CD or DVD. These other file formats or media types may be obtainable, for example, at a brick and mortar store or other establishment.

In some embodiments, virtual tokens may be directly downloaded at an event onto the memory strip or device of a purchaser's credit card, smart card, or other such device. This eliminates the need for the purchaser to carry a PDA or other such device to the event, and leverages the existing prevalence of credit cards. Such embodiments may become particularly desirable as the credit card industry implements smart cards having greater sophistication and functionality.

One specifically contemplated use of tokens in accordance with the teachings herein is to associate a token with a particular live performance so that a person attending the performance can obtain a recording of that specific performance, thereby enhancing the purchaser's experience at the event by providing a customized recording. In some instances, the cost of the token could be included in the original price of admission. For example, one or more scanners could be provided at the event such that a purchaser's token could be associated with that particular performance. Also, the tickets themselves could contain individual PIN numbers or identification codes which enable all or some (e.g., VIP tickets and/or non-lawn seats) of the ticket holders to gain access to digital copies of the live performance, exclusive singles by that artist, other albums, merchandise, or the like. Such an embodiment may enable a musician, producer or other entity to leverage the different markets (and/or consumer preferences) that exist for recordings of live performances as opposed to studio recordings.

In some embodiments of the methodologies described herein, downloading of the digital media files may commence at the event itself. For example, if a person who purchases a token at the event has a PDA or other such device that provides Internet or network connectivity, the token may be utilized as a means to grant permission for the purchaser to download one or more files from a site. Downloading may then commence at the point of purchase, and may be continued through any available public or private network, such as a WiFi or WiMax wireless network. In some embodiments, wireless networks may be specifically provided at the point of purchase for this purpose. Consequently, downloading of the files may be completed before the user has even left the event site. In this way, the digital media files may be available for the purchaser's enjoyment, for example, on the way home from the event.

It will also be appreciated that the systems and methodologies described herein provide numerous opportunities for various business entities to share in the brand recognition and advertising opportunities and revenues associated with the digital media distribution, and to do so in unique ways. For example, the tokens described herein may be co-branded with the brands of various entities, such as, for example, those of the artist, the distributor, the promoter, the network service provider, and/or the party or parties providing bandwidth for any downloads enabled or facilitated by the token.

Moreover, various traffic driving mechanisms may be utilized to reflect the relative investment or interest of various parties in the digital media distribution. For example, tokens may be sold by a token distributor at various price points. The price points may be selected such that, at lower price points, less Internet traffic is driven to the purchaser's website or to websites designated by the purchaser, while higher or premium price points enable the purchaser to capture a higher volume of traffic and any associated advertising opportunities. As a specific example, at lower price points, the token may drive traffic almost exclusively through one or more websites associated with, or designated by, the token distributor, while at higher price points, the token may drive traffic almost exclusively through one or more websites associated with, or designated by, the token purchaser (in this specific context, the token purchaser refers to the party that will offer the tokens for resale, as opposed to the end user purchaser of the token).

While several of the embodiments described herein contemplate sales of tokens as a significant revenue generator, in some embodiments, the tokens may be offered for free, or at a reduced price. In these embodiments, consideration for the tokens being offered for free or at a reduced price may be based on the sale of consumer or purchaser data collected at redemption of the token. In other embodiments, the tokens may be provided free of charge to an artist or entity, but that artist or entity is then charged a fee upon redemption of the token.

In some embodiments, the price at which the tokens are sold is controlled by the artist or entity selling them. In such embodiments, the price may be selected, for example, based on desired profit margin, the recognition of premium products, or on other criteria.

In some embodiments of the systems and methodologies described herein, one or more parties, such as, for example, an artist, distributor, promoter, or record label, may be able to designate the transfer of a certain percentage of revenues arising from the sale of tokens to one or more charities or other third parties. This embodiment may be particularly desirable if a concert or other such event is held to benefit a particular cause or charity. In some cases, live, interactive, or digital feedback and analysis of funds raised for the various causes may be provided to the organizers and/or participants of such an event.

The systems and methodologies disclosed herein may utilize various file distribution systems and/or file sharing protocols to facilitate the distribution of digital media and other content to purchasers or owners of a token without incurring the corresponding consumption in costly server and bandwidth resources. Such file distribution systems and file sharing protocols may include, without limitation, peer-to-peer file distribution and/or file sharing protocols such as those marketed under the trade names BITTORRENT™ and eDONKEY™.

The file distribution and file sharing protocols so utilized may be adapted to break a digital media file or files into smaller fragments, such as, for example, a quarter of a megabyte (256 kB) in size. In some embodiments, the size of the fragment may depend on the size of the original file. Thus, for example, the software which implements the file distribution or protocol may utilize larger fragments for the distribution of larger digital media files, possibly up to some predetermined maximum fragment size which may be determined, for example, by common server settings governing maximum packet sizes. Peers may then download missing fragments from each other and may upload those that they already have to other peers requesting them. The protocol may be adapted to choose the peer with the best network connections for the fragments that it is requesting.

In some embodiments, the software utilized to distribute digital media in accordance with the teachings herein may be adapted to establish a temporary ad-hoc peer-to-peer (P2P) network or “swarm” to distribute a particular file. To increase the overall efficiency of the swarm, the software may be adapted such that the software installed on client machines will request those file fragments from peers that, at the time of the request, are available from the fewest number of peers. In some instances, this may have the effect of avoiding bottlenecks and making most of the file fragments widely available across several machines.

The file fragments need not be downloaded in sequential order and may be reassembled into a complete file by the software installed on a client machine. Moreover, the software may be adapted to permit clients to commence uploading file fragments to their peers before the client has downloaded an entire file. This approach may permit each client to obtain the complete file so long as there is at least one distributed copy of the file.

In a specific embodiment of the foregoing methodology, a client desiring to download a digital media file first downloads a distribution file and opens it in the client software. The distribution file provides the client with the address of a tracker which, in turn, maintains a log of which users are downloading the file and where its fragments reside. For each available source, the client software considers which blocks of the file are available, and then requests the rarest block (that is, the file available from the least number of peers) it does not yet have. This approach increases the likelihood that peers will have blocks to exchange. As soon as the client finishes importing a block, it may hash it to make sure that the block matches what the distribution file said it should be.

The distribution system described above may provide exceptional speed, since all of the nodes in a group concentrate on transferring a single file or collection of files. In some embodiments, the system may be equipped with a means to encourage clients to upload files. For example, the system may have a credit system whereby a client rewards other clients that upload to it by increasing their priority in its queue.

To alleviate the problem of uncertain or variable download speed, the systems and software described herein may be adapted so that a dedicated server or servers can commit to a larger number of distribution files per collection of digital media files. For example, if the collection of digital media files consists of the songs in an album, the dedicated server or servers may commit to, for example, ⅓ or ½ of the distribution files for each album. Additionally, the software may be adapted such that, when a server completes its uploading commitments, it calculates the time the seeder's distribution file will upload. If the server has the capacity and ability to upload the specific distribution file faster, then the system may be adapted to override, cancel, and replace the current seeder's upload of the particular distribution file, thereby increasing speeds across the board.

In some embodiments of the software and systems described herein, a client may have associated with it a participation level which increases when files or fragments are uploaded, and which decreases when files or fragments are downloaded. When a client uploads a file or fragment to another party, the client with the highest participation level receives the file or fragment first, and then uploads it on to the person with the next highest participation level, and so on. This approach can be visualized as a pyramid, in which the clients having the most upload bandwidth available are present at the top of the pyramid, and in which the clients having less bandwidth are present on progressively lower levels of the pyramid. In many applications, this approach may be the most efficient way to distribute a file to a large number of users, since it is likely that even clients at the bottom of the pyramid will obtain the file or fragment faster than if the file or fragment was served by a non peer-to-peer (P2P) method.

It will be appreciated that the systems and methodologies described herein, and the distribution file described above, enable its subscribers to offer several more file types and associations for users to download digital media content which they have purchased. For example, large .wav files may be offered to clients with “excellent” sharing ratios, since such clients will have offered sufficient cost savings to the subscriber. In some embodiments of the systems and methodologies described herein, uploading may be encouraged by giving uploaders download credits with a certain redemption value. Thus, for example, in such embodiments, the uploader may earn free music or other digital media content just for leaving his or her computer turned on.

It will further be appreciated that other file types and extensions may be utilized in the systems and methodologies describer herein. These may include files which are more “loss-resistant”, meaning that when they are decompressed and decoded, a higher quality of sound can be maintained relative to the original .wav file.

The systems and methodologies may incorporate various security measures to ensure compliance with relevant laws, including copyright laws. For example, PIN authorization or other such identity confirmation or authorization measures may be required prior to uploading the distribution file.

The systems and methodologies may also utilize virtual distribution files. This concept is based on the distributed tracker approach and is used to describe some web resource which may be, for example, a copyrighted digital media file. The virtual distribution file may be implemented using a special messaging protocol and may require an appropriate plug-in. Anatomic P2P is another possible approach which may be utilized herein, and which uses a decentralized network of nodes that route traffic to dynamic trackers. A subscriber's dedicated server or servers may be used as dynamic trackers for this purpose.

The systems and methodologies may also utilize web seeding. The advantage of this feature is that a site may distribute a distribution file for a particular file or batch of files, and may make those files available for download from that same web server application. This can simplify seeding and load balancing greatly once support for this feature is implemented in the various distribution file clients. Such an approach may make using the distribution file almost as easy for a web publisher as simply creating a direct download, while allowing some of the upload bandwidth demands to be placed upon the downloaders (who normally use only a very small portion of their upload bandwidth capacity). Details of this type of approach may be found, for example, at http://bittornado.com/docs/webseed-spec.txt. In such an approach, TRSS feeds layered on top keep track of the content, and because the software does cryptographic hashing of all data, subscribers to the feed can be sure that they are getting the expected content.

Also, with a block of bytes which is the same length as a piece in the distribution file and which has the same digest as that piece, one could irreparably “poison” a distribution file. Though the chance of collision is designed to be remote, this possibility could keep some from using this approach for critical files. For this reason, a subscriber could offer users an additional download in case their first attempt to download, using the software, is unsuccessful or renders a corrupt file. In the unlikely case that someone should turn certain distribution files into viruses or attempt to corrupt files on the subscriber's system, a backup of the original digital media file, unaltered from its original state, may be maintained. This file can be used to create a new distribution file. The new file may be manually broken down into completely different blocks, so that the old, “poisoned” blocks are no longer recognized by the software when a user seeks to download that particular file.

It will be appreciated that, by employing software (open source or licensed) of the type described above, the costs for hosting and uploading digital media files to token purchasers may be significantly decreased. Moreover, this approach provides a logical method for implementing a website for the distribution of digital media files which, by its nature, will utilize a large amount of bandwidth.

The systems and methodologies described herein will also preferably enable site visitors, consumers, and/or token purchasers to disable their uploading functions if they do not wish to participate. Hence, users will preferably be able to completely opt out of downloading the initial distribution file, and may download digital media files directly from the appropriate server or host. However, it is also preferred that the user will be informed of the advantages of using the distribution file, which may include (a) faster downloads; (b) cost savings from decreased bandwidth requirements; (c) availability to offer larger, more high quality digital media files, and a larger catalogue of digital media files in general; (d) the cost savings can be passed on to the artists, consumers, and general public in the form of charitable contributions, and possibly incentives such as free download credits for users who are frequent “uploaders” or “seeders”.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A method for distributing digital media, comprising:
providing a web site from which a plurality of digital media files are accessible, wherein each digital media file contains digital media associated with a particular artist;
providing a plurality of tokens, wherein each token has a unique identification code which can be utilized to gain access to digital media files which are associated with the identification code; and
associating the identification codes of said plurality of tokens with at least one of said plurality of digital media files, thereby creating a plurality of associated tokens.

2. The method of claim 1, further comprising:
distributing the plurality of associated tokens to the artist.

3. The method of claim 1, wherein each of the plurality of associated tokens enables a user to download digital media from the digital media files that the token is associated with.

4. The method of claim 3, wherein the token has a monetary value associated with it.

5. The method of claim 1, wherein the identification code can be utilized to gain access to digital media files via the website.

6. The method of claim 1, wherein the identification code can be utilized to gain access to digital media files via another website.

7. The method of claim 1, wherein the identification code can be utilized to gain access to digital media files from a store.

8. The method of claim 1, wherein each of said plurality of tokens is a plastic card.

9. The method of claim 1, wherein the digital media downloadable with the token has a monetary value associated with it, and wherein the associated token enables a user to download digital media whose value does not exceed the monetary value associated with the token.

10. The method of claim 9, wherein the artist sells the tokens at an event.

11. The method of claim 10, wherein the sales price of the tokens at the event are discounted below the monetary value associated with the token.

12. The method of claim 10, wherein the digital media can be purchased from the website, and wherein the cost of digital media purchased with the token is discounted relative to the cost of purchasing the digital media from the website.

13. The method of claim 1, further comprising:
distributing the plurality of associated tokens at an event.

14. The method of claim 13, wherein the event is associated with at least one artist, and wherein the associated tokens are associated with digital media files associated with the at least one artist.

15. The method of claim 14, wherein the digital media files are audio files, wherein the associated tokens are distributed by a record label, and wherein the at least one artist further includes at least one other artist represented by the record label.

16. The method of claim 15, wherein the associated tokens are distributed at the event for free.

17. The method of claim 1, wherein the digital media files are video files.

18. The method of claim 1, wherein the digital media files are image files.

19. A system for distributing digital media, comprising:
a web site from which a plurality of digital media files are accessible, wherein each digital media file contains digital media associated with a particular artist; and
a plurality of tokens, wherein each token has a unique identification code which can be utilized to gain access to digital media files which are associated with the identification code, and wherein the identification codes of said plurality of tokens are associated with at least one digital media file which is accessible from the website and which is associated with a particular artist.

20. The system of claim 19, wherein each of the plurality of associated tokens enables a user to download digital media from the digital media files that the token is associated with.
